(19) United States
(12) Patent Application Publication
(10) Pub. No.: US 2015/0361702 A1
(43) Pub. Date: Dec. 17, 2015

(54) MODULAR WINDOW BALANCE ASSEMBLY

(71) Applicant: Caldwell Manufacturing Company North America, LLC, Rochester, NY (US)

(72) Inventors: Wilbur James Kellum, III, Hilton, NY (US); Richard S. DeNormand, Rochester, NY (US)

(21) Appl. No.: 14/836,188

(22) Filed: Aug. 26, 2015

Related U.S. Application Data
(63) Continuation of application No. 13/827,189, filed on Mar. 14, 2013.

(51) Int. Cl. E05D 13/00; E05C 17/60

(52) U.S. Cl. CPC E05D 13/1276; E05D 13/04

(57) ABSTRACT

A set of components is provided that may be adapted for constructing a plurality of window balance assemblies. The set of components may include a spring module and a carrier module. The spring module may include a housing engaging a first portion of a spring member. The housing may have a first engagement feature disposed at a first end and a second engagement feature disposed at a second end opposite the first end. The carrier module may be configured to receive a portion of a window sash and may include a third engagement feature. The third engagement feature may be connectable with the first engagement feature. The third engagement feature may also be connectable with the second engagement feature.

This application is a continuation of U.S. patent application Ser. No. 13/827,189 filed on Mar. 14, 2013. The entire disclosure of the above application is incorporated herein by reference.

### FIELD

### Background

This section provides background information related to the present disclosure and is not necessarily prior art.

Modern window assemblies in residential, commercial and industrial buildings may include one or more window sashes that are movable within a window jamb. Window sashes that move vertically to open and close often include two or more window balance assemblies. The balance assemblies urge the window sash upward (i.e., toward an open position for a lower sash or toward a closed position for an upper sash) to assist a user in moving the window sash and to retain the window sash at a position selected by the user.

### SUMMARY

This section provides a general summary of the disclosure, and is not a comprehensive disclosure of its full scope or all of its features.

In one form, the present disclosure provides a set of components that may be adapted for constructing a plurality of window balance assemblies. The set of components may include a spring module and a carrier module. The spring module may include a housing engaging a first portion of a spring member. The housing may have a first engagement feature disposed at a first end and a second engagement feature disposed at a second end opposite the first end. The carrier module may be configured to receive a portion of a window sash and may include a third engagement feature. The third engagement feature may be connectable with the first engagement feature. The third engagement feature may also be connectable with the second engagement feature.

In some embodiments, the spring module and the carrier module may form a movable-coil window balance assembly when the first and third engagement features are connected to each other.

In some embodiments, the second engagement feature of the spring module may releasably engage a bracket module that directly engages an uncurled end of the spring member.

In some embodiments, the spring module and the carrier module may form a fixed-coil window balance assembly when the second and third engagement features are connected to each other.

In some embodiments, the carrier module may include a spring engagement feature adapted to receive a second portion of the spring member.

In some embodiments, the first engagement feature may be connectable with a bracket module that includes a debris dam.

In some embodiments, the third engagement feature may include a pair of upwardly extending projections.

In some embodiments, the first engagement feature may include a pair of slots sized and shaped to receive the projections.

In some embodiments, the second engagement feature may include a pair of projections.

In some embodiments, the second engagement feature and the third engagement feature may be connectable with each other by a bracket module that may be removably engageable with the carrier module and the spring module.

In some embodiments, the housing of the spring module may be formed from first and second identical housing portions connected to each other.

In some embodiments, the portion of the window sash may include a pivot bar. The carrier module may include a rotatable cam that is engageable with the pivot bar.

In some embodiments, the carrier module may include an elongated slot aligned with an aperture in which the cam is rotatable.

In some embodiments, a central portion of the carrier module may be resiliently flexible.

In another form, the present disclosure provides a method of installing a window balance assembly onto a window jamb. The method may include inserting a carrier module into a jamb channel of the window jamb through a cutout disposed between first and second ends of the jamb channel and inserting a spring module into the jamb channel through the cutout. The spring module may be connected to the carrier module inside of the jamb channel.

In some embodiments, the spring module and the carrier module may be inserted through the cutout one at a time.

In some embodiments, connecting the spring module to the carrier module may include connecting a first engagement feature extending from a body of the carrier module with a second engagement feature of a housing of the spring module.

In some embodiments, connecting the spring module to the carrier module may include connecting an uncurled end of a spring member extending from the spring module to an attachment feature of the carrier module.

In some embodiments, the method may include inserting a bracket module into the jamb channel through the cutout. In some embodiments, the bracket module may be inserted into the jamb channel separately from the spring module and the carrier module.

In some embodiments, the method may include connecting the bracket module to one of the carrier module and the spring module inside of the jamb channel.

In some embodiments, the method may include connecting the bracket module to a wall of the jamb channel.

In some embodiments, the method may include positioning the bracket module within the jamb channel to form a debris dam restricting debris from accumulating on at least one of the spring module and the carrier module.

In some embodiments, the method may include inserting a pivot bar of a window sash into a cam of the carrier module through a slot in the window jamb after the carrier module is received in the jamb channel.

In some embodiments, inserting the carrier module into the jamb channel may include resiliently bending the carrier module to fit the carrier module through the cutout. In some embodiments, the cutout may include a first vertical height and the carrier module may include a second vertical height that is greater than the first vertical height.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a partial front view of a window assembly including window balance assemblies according to the principles of the present disclosure;

FIG. 2 is a perspective view of a window balance assembly in an uninstalled configuration according to the principles of the present disclosure;

FIG. 3 is an exploded perspective view of the window balance assembly of FIG. 2;

FIG. 4 is a side view of the window balance assembly of FIG. 2 with a carrier module in an unlocked position;

FIG. 5 is a side view of the window balance assembly of FIG. 2 with a carrier module in a locked position;

FIG. 6 is a partially cutaway perspective view of the window balance assembly installed within a window jamb according to the principles of the present disclosure;

FIG. 7 is a perspective view of another window balance assembly in an uninstalled configuration according to the principles of the present disclosure;

FIG. 8 is a partially cutaway perspective view of the window balance assembly of FIG. 7 installed within a window jamb according to the principles of the present disclosure;

FIG. 9 is a perspective view of yet another window balance assembly in an uninstalled configuration according to the principles of the present disclosure;

FIG. 10 is a partially cutaway perspective view of the window balance assembly of FIG. 9 installed within a window jamb according to the principles of the present disclosure;

FIG. 11 is a cross-sectional view of the window balance assembly through Line 11-11 of FIG. 10;

FIG. 12 is a perspective view of another carrier module attached to a spring module of a window balance assembly; and

FIG. 13 is a perspective view of yet another carrier module attached to the spring module.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

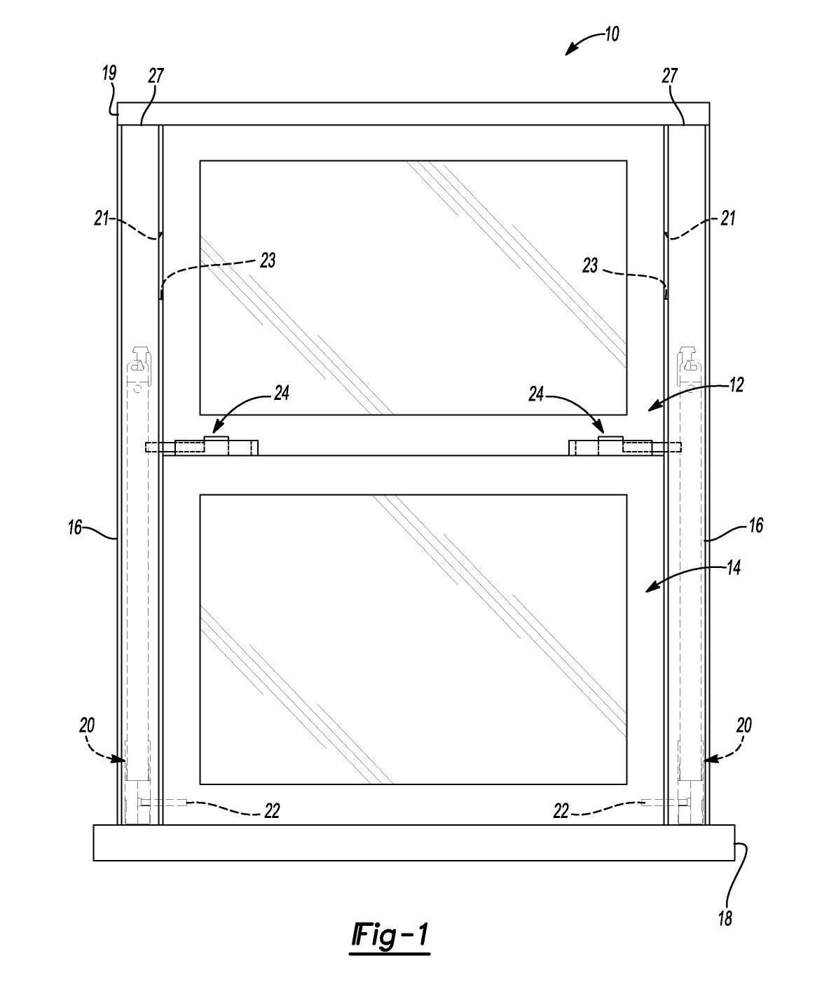

With reference to FIG. 1, a window assembly 10 is provided that may include an upper sash 12, a lower sash 14, a pair of window jambs 16, a window sill 18, a header 19 and two or more window balance assemblies or cartridges 20. In the particular embodiment illustrated in FIG. 1, the upper sash 12 is fixed relative to the window sill 18 and header 19 (i.e., in a single hung window assembly). However, in some embodiments, the upper sash 12 may be movable relative to the window sill 18 and header 19 between a raised or closed position and a lowered or open position (i.e., in a double hung window assembly). The lower sash 14 may be raised and lowered between open and closed positions and may be connected to the window balance assemblies 20 which assist a user in opening the lower sash 14 and maintain the lower sash 14 in a desired position relative to the window sill 18.

The lower sash 14 may include a pair of pivot bars 22 and a pair of tilt latch mechanisms 24. The pivot bars 22 may extend laterally outward in opposing directions from a lower portion of the lower sash 14 and may engage corresponding ones of the window balance assemblies 20, as will be subsequently described. The tilt latch mechanisms 24 may extend laterally outward in opposing directions from an upper portion of the lower sash 14 and may selectively engage corresponding ones of the window jambs 16. The tilt latch mechanisms 24 may be selectively actuated to allow the lower sash 14 to pivot about the pivot bars 22 relative to the window jambs 16 to facilitate cleaning of an exterior side of the window assembly 10, for example.

It will be appreciated that in a double hung window assembly, the upper sash 12 may also be connected to two or more window balance assemblies to assist the user in opening the upper sash 12 and maintaining the upper sash 12 in a selected position relative to the window sill 18. In such a window assembly, the upper sash 12 may also include tilt latches and pivot bars to allow the upper sash 12 to pivot relative to the window jambs 16 in the manner described above.

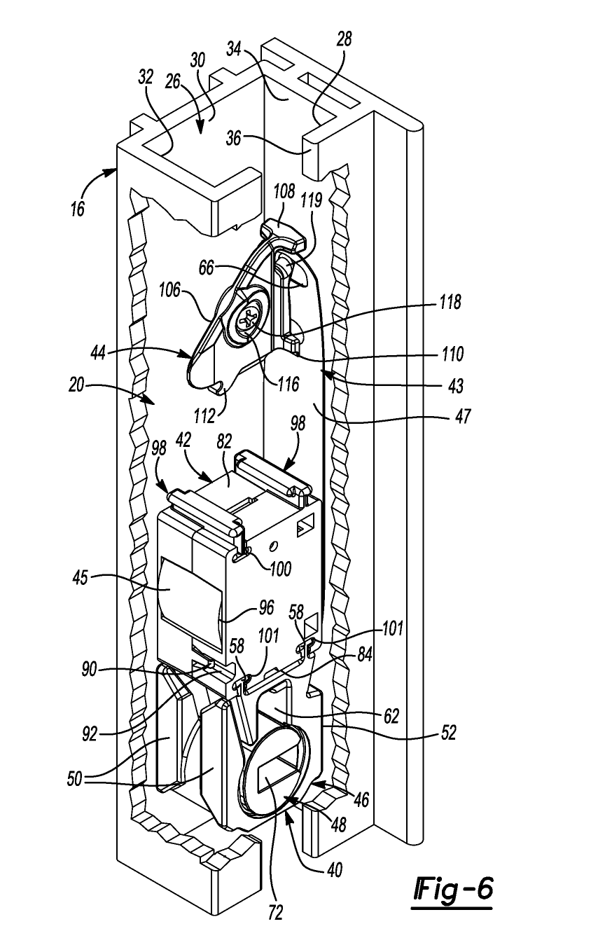

As shown in FIG. 6, each of the window jambs 16 may include a jamb channel 26 defined by a first wall 28, a second wall 30 opposite the first wall 28, and third and fourth walls 32, 34 disposed perpendicular to the first and second walls 28, 30. The first wall 28 may include a vertically extending slot 36 adjacent the lower sash 14. The window balance assembly 20 may be installed within the jamb channel 26. As shown in FIG. 1, the pivot bar 22 may extend through the slot 36 and into the jamb channel 26 to engage the window balance assembly 20. The tilt latch mechanism 24 may also selectively engage the slot 36 to lock the lower sash 14 in an upright position (FIG. 1).

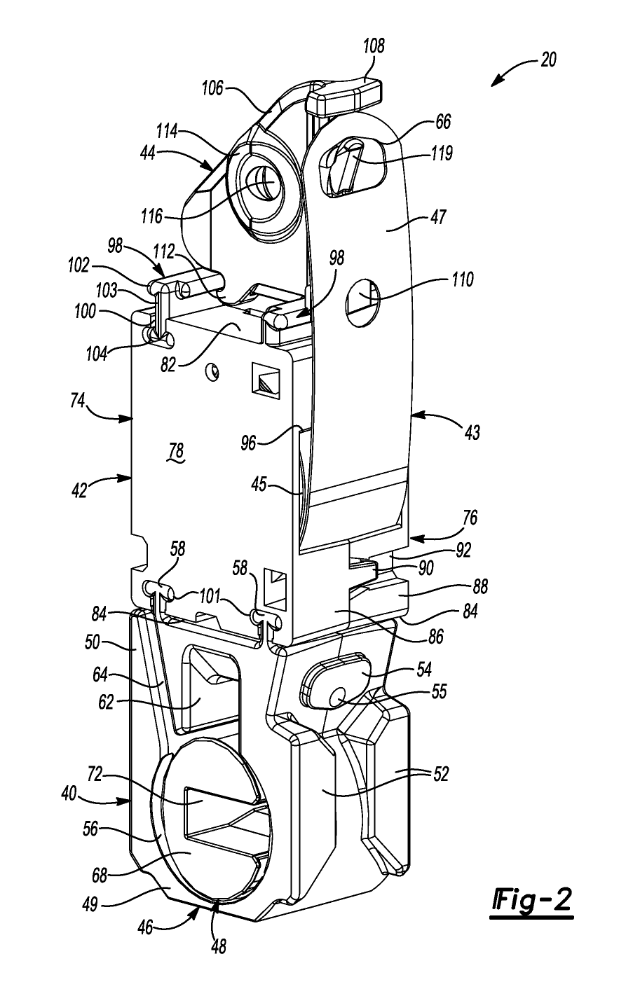

Referring now to FIGS. 2-6, each window balance assembly 20 may include a carrier module 40, a spring module 42, and a bracket module 44. The window balance assembly 20 may be modular, in that one or more of the carrier module 40, spring module 42 and bracket module 44 shown in FIGS. 2-6 can be replaced with a different carrier module, spring module and/or bracket module to suit a given application or set of specifications. It will also be appreciated that one or more of the carrier module 40, spring module 42 and bracket module 44 could be incorporated into other configurations or types of window balance assemblies (e.g., moving-coil, fixed-coil, constant-force, non-constant-force, etc.). Furthermore, while the figures illustrate window balance assemblies having a single spring module 42, in some embodiments, two or more spring modules 42 could be incorporated into a single window balance assembly to increase a spring rate of the window balance assembly. Additionally or alternatively, two or more curl springs 43 may be disposed within a single spring module.

The window balance assembly 20 may be initially assembled and shipped in an uninstalled or shipping configuration (shown in FIG. 2) and may be subsequently installed onto the window assembly 10 and placed in an installed configuration (shown in FIG. 6) by a window manufacturer, a construction or renovation contractor, or a homeowner, for example. The window balance assembly 20 may be a movable-coil type window balance assembly, as the spring module 42 and carrier module 40 may be vertically movable with the lower sash 14 relative to the window jamb 16 and the bracket module 44 may be fixed relative to the window jamb 16 when the window balance assembly 20 is fully installed.

The carrier module 40 (also referred to as a shoe) may engage the pivot bar 22, which in turn, may engage the lower sash 14. The spring module 42 may removably engage the carrier module 40 and house a curled portion 45 of a curl spring 43. The bracket module 44 may engage an uncurled end 47 of the curl spring 43 and may be fixed relative to the window jamb 16, as shown in FIG. 6. The curl spring 43 may resist being uncurled such that the curl spring 43 exerts an upward force on the spring module 42 and carrier module 40, thereby biasing the lower sash 14 toward the open position.

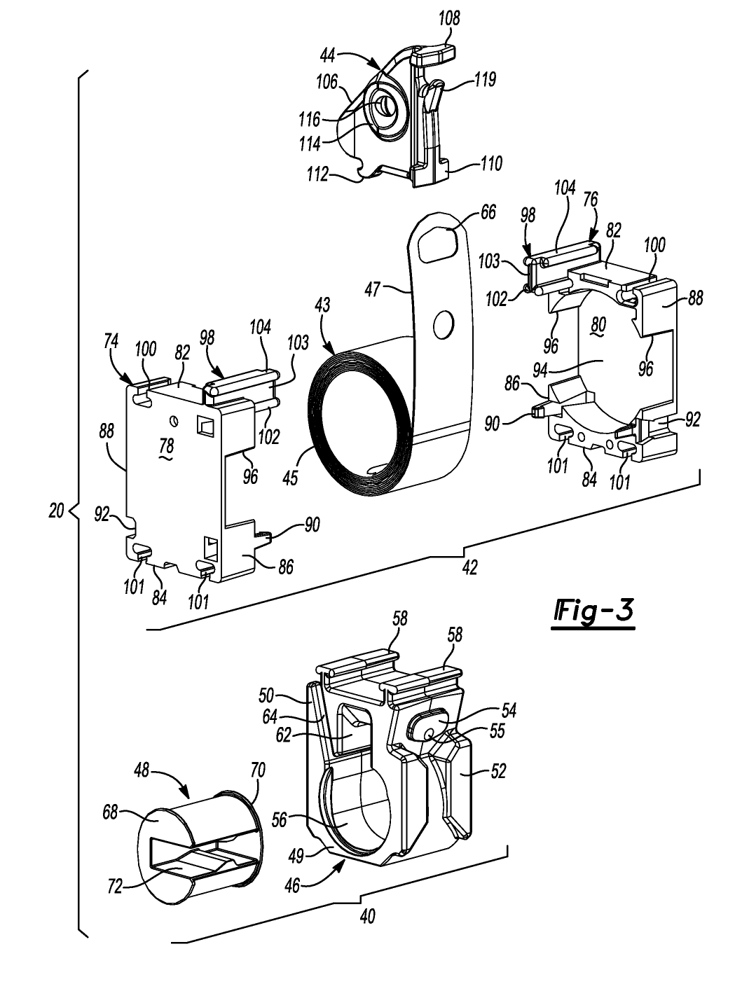

The carrier module 40 may include a carrier 46 and a cam 48. The carrier 46 can be molded and/or machined from a polymeric or metallic material, for example, and may include a body 49, one or more resiliently flexible arms 50, guide surfaces 52, an attachment boss 54, an aperture 56, and a pair of projections 58. The flexible arms 50 and guide surfaces 52 may extend from the body 49 on opposite sides of the aperture 56. The aperture 56 may extend through the body 49 and may include a generally cylindrical or elliptic-cylindrical shape. The aperture 56 may be in communication with a vertically extending slot 62. The flexible arms 50 may define an angled slot 64 that communicates with the aperture 56. As shown in FIGS. 2 and 3, the attachment boss 54 may include a threaded aperture 55 and a profile that substantially matches an engagement aperture 66 in a distal end of the uncurled end 47 of the curl spring 43. The projections 58 may be generally T-shaped members extending vertically upward from the body 49.

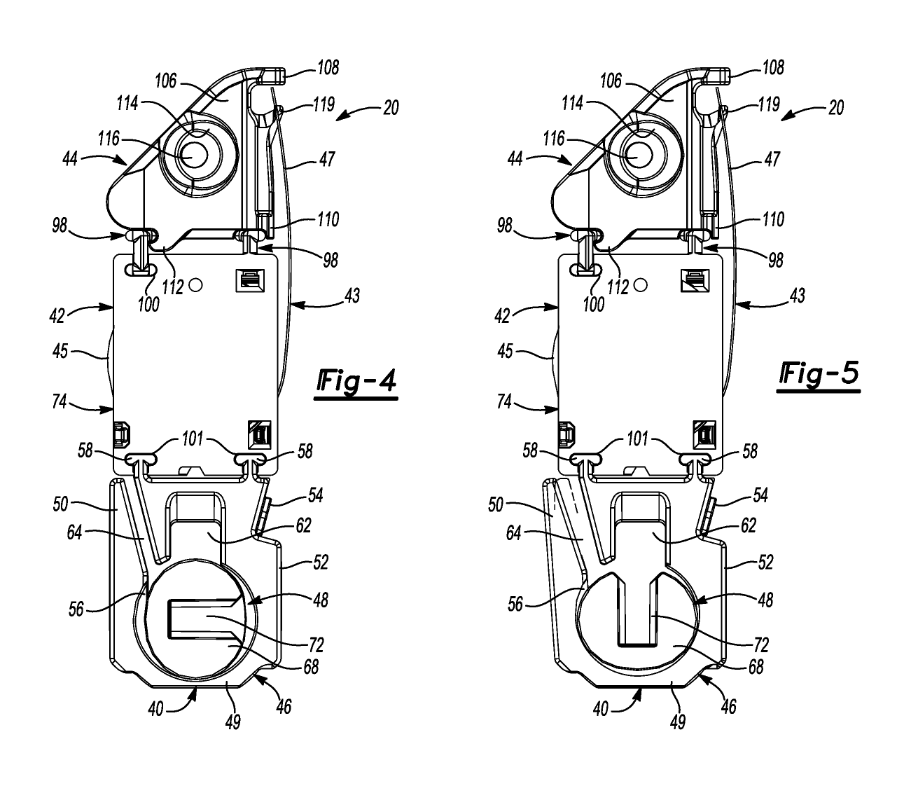

The cam 48 may be an elliptic cylinder having first and second end faces 68, 70 and a slot 72 extending between the end faces 68, 70 and through the first end face 68 (as shown in FIG. 3). The slot 72 of the cam 48 of each of the window balance assemblies 20 may receive a corresponding one of the pivot bars 22 extending from the lower sash 14. The cam 48 may be rotatable within the aperture 56 between an unlocked position (FIG. 4) corresponding to an upright position of the lower sash 14 and a locked position (FIG. 5) corresponding to a tilted position of the lower sash 14. Rotation of the cam 48 may allow the lower sash 14 to pivot about a longitudinal axis of the pivot bar 22 between the upright position and the tilted position.

When the cam 48 is rotated into the locked position, the elliptical shape of the cam 48 causes the arms 50 of the carrier 46 to flex outward, as shown in FIG. 5. With the arms 50 flexed outward, the arms and the guide surfaces 52 may be forced against third and fourth walls 32, 34 of the jamb channel 26, thereby increasing the friction between the carrier 46 and the jamb channel 26 to lock the carrier module 40 and spring module 42 relative to the jamb channel 26. As shown in FIG. 5, when the cam 48 is in the locked position, the slot 72 in the cam 48 may be substantially aligned with the vertically slot 62 in the carrier 46. This alignment between the slots 62, 72 allows the pivot bar 22 to be inserted into and removed from the slot 72 (and hence install and remove the lower sash 14) while the carrier module 40 and the spring module 42 are locked in place within the jamb channel 26.

When the cam 48 is oriented such that the slot 72 is oriented horizontally relative to the carrier 46, the arms 50 of the carrier 46 may return to the unlocked or unrestricted position, such that the carrier 46 may be generally unrestricted from moving upward and downward in the window jamb 16 as the lower sash 14 moves between the open and closed positions.

Referring now to FIGS. 2 and 3, the spring module 42 may include the curl spring 43, a first housing portion 74 and a second housing portion 76. The first and second housing portions 74, 76 may be identical components that fit together to form a housing for the curl spring 43. Each of the first and second housing portions 74, 76 may include an exterior face 78, an interior face 80, a top end 82, a bottom end 84, a first side 86, and a second side 88. A barbed protuberance 90 may be disposed at or proximate to the first side 86 and may extend outward from the interior face 80. A second slot 92 may be formed in the second side 88 generally opposite the barbed protuberance 90 such that when the first and second housing portions 74, 76 are assembled together, the barbed protuberances 90 may engage the second slots 92 (shown best in FIG. 2).

The interior face 80 may include generally cylindrical recesses 94. When the first and second housing portions 74, 76 are assembled together, the cylindrical recesses 94 cooperate with each other to form a nest that receives the curled portion 45 of the curl spring 43. Openings 96 that are in communication with the recess 94 may be formed in the first and second sides 86, 88 through which the uncurled end 47 of the curl spring 43 may extend toward the bracket module 44.

The first and second housing portions 74, 76 may also include a projection 98 and a third slot 100 disposed at the top end 82. The projection 98 may extend from the exterior face 78 beyond the interior face 80 and may include a generally I-shaped cross-section having upper and lower flanges 102, 104 and a body 103 extending therebetween. The third slots 100 may be sized and shaped to enable the third slots 100 of the first housing portion 74 and the second housing portion 76 to slidably engage the lower flanges 104 of the second housing portion 76 and the first housing portion 74, respectively.

The first and second housing portions 74, 76 may also include a pair of generally T-shaped fourth slots 101 disposed in the bottom end 84. When the first and second housing portions 74, 76 are assembled together, the slots 101 of the first housing portion 74 are aligned with the slots 101 of the second housing portion 76. The slots 101 may be sized and shaped to receive the T-shaped projections 58 extending from the carrier 46. The fit between the projections 58 and the slots 101 may be press-fits or interference fits, for example, so that the spring module 42 may be securely, yet removably attached to the carrier module 40.

Referring now to FIGS. 2-6, the bracket module 44 can include any suitable mounting bracket. For example, the bracket module 44 may include a mounting bracket of one of the types disclosed in Assignee's commonly owned U.S. patent application Ser. No. 13/576,440, the disclosure of which is hereby incorporated by reference. In the particular embodiment illustrated in FIGS. 2-6, the bracket module 44 may be formed from a polymeric material, for example, and may include a body portion 106, a head 108, a base 110, and a tab 112. The bracket module 44 may be substantially symmetric about a plane defining the body portion 106 and extending through the head 108, base 110, and tab 112.

The body portion 106 may include a pair of bosses 114 disposed on opposite sides of the body portion 106. A mounting aperture 116 may extend through both of the bosses 114. As shown in FIG. 6, a screw 118 may extend through the mounting aperture 116 and engage the second wall 30 of the jamb channel 26 to secure the bracket module 44 to the window jamb 16. A latch 119 may extend generally upward and outward from the body portion 106 between the head 108 and the base 110. The latch 119 may engage the engagement aperture 66 in the curl spring 43 (shown in FIGS. 2 and 4-6). The base 110 may extend laterally outward from the body portion 106 and may engage one of the projections 98 of the spring module 42, as shown in FIGS. 4 and 5.

The tab 112 may extend from body portion 106 and may engage at least a portion of the other one of the projections 98. In some embodiments, the tab 112 may slide and/or snap into and out of engagement with the projection 98 or breakaway from the projection 98 as the screw 118 is driven into the window jamb 16.

With continued reference to FIGS. 1-6, operation of the window balance assembly 20 will be described in detail. As described above, the window balance assembly 20 may be initially assembled and shipped in a shipping configuration shown in FIGS. 2 and 4. The window balance assembly 20 can be maintained in the shipping configuration up until the window balance assembly 20 is ready to be installed in the window jamb 16. The window balance assembly 20 could even remain the shipping configuration up until the final steps of installation of the window balance assembly 20 into the window assembly 10. In this manner, the potential for damage and/or misalignment of the various components of the window balance assembly 20 is reduced.

Installation of the window balance assembly 20 may begin by inserting the window balance assembly 20 into the jamb channel 26. This can be done by inserting the window balance assembly 20 in the shipping configuration through an open upper end 27 of the jamb channel 26 (FIG. 1) before the window jamb 16 is fastened to the header 19 of the window assembly 10, for example. To secure the bracket module 44 to the second wall 30 of the window jamb 16, the window balance assembly 20 (while in the shipping configuration) may be positioned in the jamb channel 26 such that the bracket module 44 is at a desired height therein. The screw 118 may be inserted through the mounting aperture 116 and driven into the second wall 30. As the installation of the screw 118 into the second wall 30 begins to force the bracket module 44 against the second wall 30, the screw 118 may impart a twisting or torsional force on the bracket module 44 which causes the bracket module 44 to disengage from the spring module 42.

The pivot bar 22 of the lower sash 14 may be inserted in to the cam 48 in the carrier module 40, as described above, after the bracket module 44 is secured to the window jamb 16. Thereafter, the lower sash 14 may be rotated about the longitudinal axis of the pivot bar 22 to the upright position, which causes the cam 48 to rotate into the unlocked position (FIGS. 4 and 6). In the upright position, the lower sash 14 may be vertically movable relative to the window jamb 16 between the open and closed positions. Therefore, the spring module 42 and carrier module 40 are vertically movable with the lower sash 14 relative to the window jamb 16.

An alternative method for installing the window balance assembly 20 in the window jamb 16 may begin by disassembling the carrier module 40, spring module 42 and bracket module 44 from each other and inserting the carrier module 40, spring module 42 and bracket module 44 into the jamb channel 26 one at a time through a cutout 21 (shown in FIG. 1) in the window jamb 16. The cutout 21 may be disposed in the first wall 28 of the jamb channel 26 between the header 19 and the window sill 18. In some embodiments, the cutout 21 may be too small to receive the entire window balance assembly 20 at once, but may be large enough to receive the carrier module 40, spring module 42 and bracket module 44 individually. Inserting the carrier module 40, spring module 42 and bracket module 44 into the jamb channel 26 through the cutout 21 (or removing these components from the jamb channel 26 through the cutout 21) may be particularly convenient when installing a replacement window balance assembly or a repaired window balance assembly. That is, the window balance assembly 20 can be inserted into the jamb channel 26 through the cutout 21 without disassembling the header 19 from the window jambs 16.

Once the carrier module 40 has been inserted through the cutout 21 and received in the jamb channel 26, the carrier module 40 can be held in place by the installer relative to the cutout 21 such that the projections 58 are proximate to, but just above, a lower end 23 of the cutout 21. With the carrier module 40 in this position, the spring module 42 can be inserted through the cutout 21 such that the slots 101 of the spring module 42 can be slid horizontally onto the projections 58 of the carrier module 40. Thereafter, the spring module 42 and carrier module 40 can be moved downward in the jamb channel 26 to make room for the bracket module 44 to be inserted into the jamb channel 26 through the cutout 21. Thereafter, the uncurled end 47 of the curl spring 43 can be attached to the bracket module 44 and the bracket module 44 can be attached to the second wall 30 of the jamb channel 26, as described above.

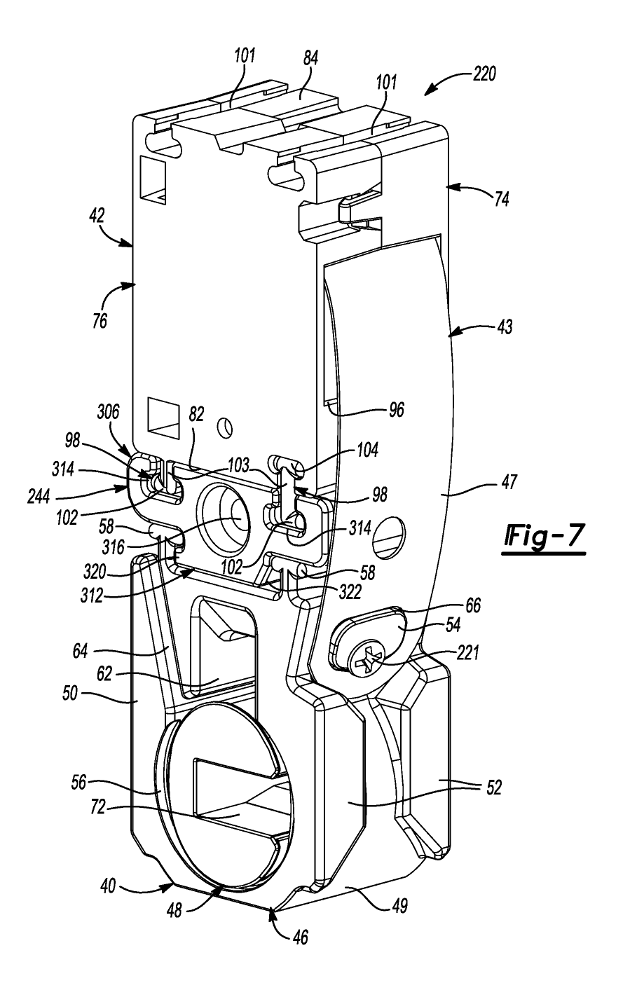

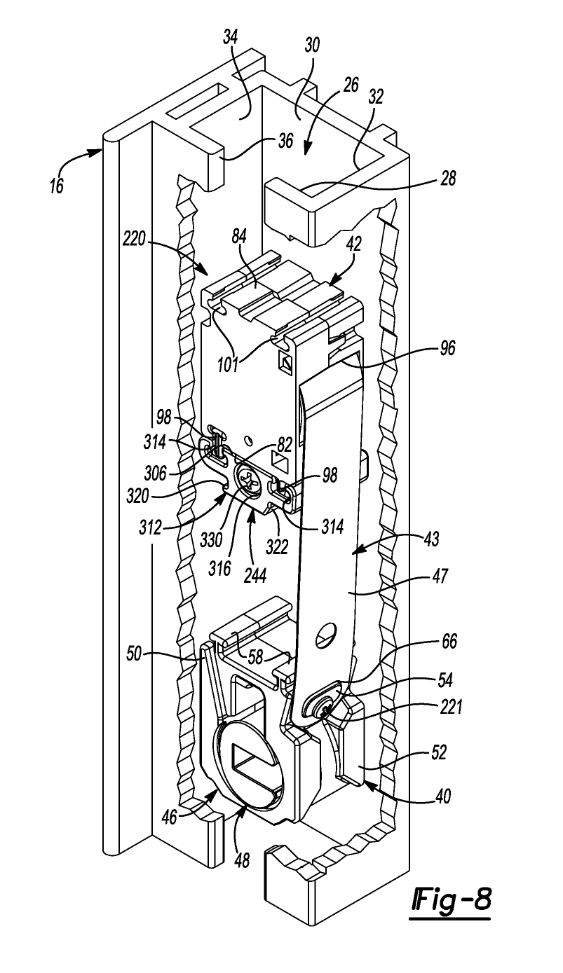

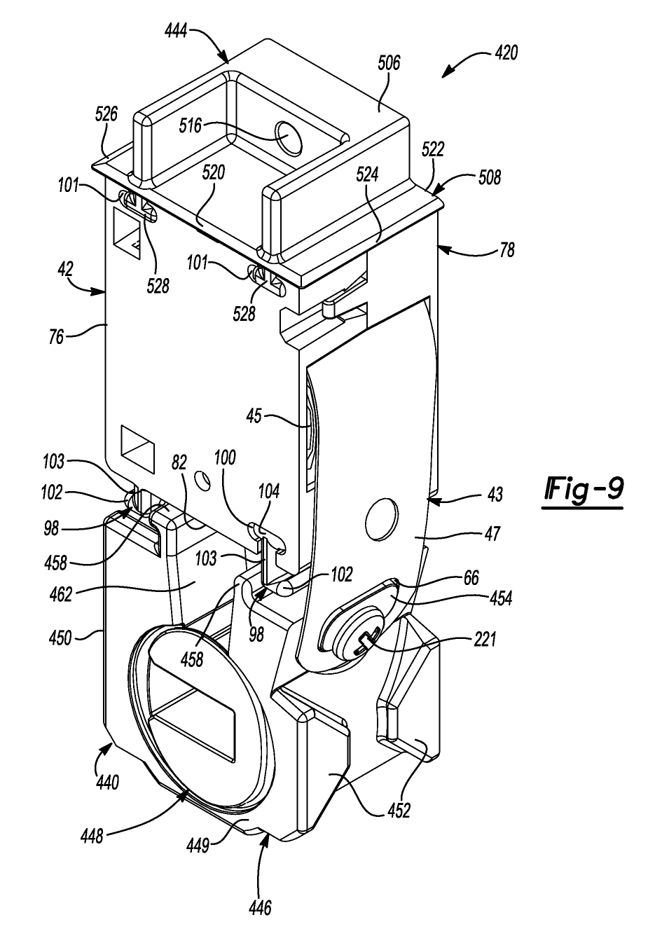

With reference to FIGS. 7 and 8, another window balance assembly 220 is provided that may include the carrier module 40 and spring module 42 described above, but in a different configuration. That is, the window balance assembly 220 is a fixed-coil window balance assembly, unlike the window balance assembly 20, which is a movable-coil window balance assembly. As described above, when used in the window balance assembly 20, the carrier module 40 and spring module 42 are used to form a movable-coil window balance assembly. As will be subsequently described, when used in the window balance assembly 220, the carrier module 40 and spring module 42 are used to form a fixed-coil window balance assembly.

In the window balance assembly 220, the orientation of the spring module 42 relative to the carrier module 40 may be reversed such that the bottom end 84 of the spring module 42 is facing upward in the window jamb 16 and the top end 82 of the spring module 42 is facing downward. Furthermore, unlike the window balance assembly 20, in the window balance assembly 220, the uncurled end 47 of the curl spring 43 is attached to the carrier module 40. That is, the attachment boss 54 of the carrier module 40 may be received through the engagement aperture 66 of the curl spring 43. A screw 221 may engage the threaded aperture 55 in the attachment boss 54 to securely retain the uncurled end 47 of the curl spring 43 onto the carrier module 40.

In addition to the carrier module 40 and spring module 42, the window balance assembly 220 may also include a bracket module 244 disposed between the carrier module 40 and the spring module 42. The bracket module 244 may be molded and/or machined from a polymeric or metallic material, for example, and may include a body portion 306 and a tab portion 312. The body portion 306 may include a pair of generally T-shaped slots 314 and a mounting aperture 316 extending therethrough. The slots 314 may be sized and shaped to receive the T-shaped projections 98 extending from the spring module 42. The fit between the projections 98 and the slots 314 may be press-fits or interference fits, for example, so that the spring module 42 may be securely, yet removably attached to the bracket module 244.

The tab portion 312 of the bracket module 244 may include a flange 320 and a tapered portion 322. When the window balance assembly 220 is in the uninstalled configuration (shown in FIG. 7), the tab portion 312 may be received between and engaged with the projections 58 of the carrier module 40. For example, the flange 320 may engage one of the projections 58 while the other of the projections 58 may abut the tab portion 312 adjacent a base of the tapered portion 322.

To install the window balance assembly 220 in the jamb channel 26, as shown in FIG. 8, an installer may drive a screw 330 through the mounting aperture 316 and into the second wall 30 of the jamb channel 26. Once the screw 330 is driven into the second wall 30, the carrier module 40 can be separated from the bracket module 244 by pulling the carrier module 40 downward to disengage the tab portion 312 of the bracket module 244 from the projections 58 of the carrier module 40. Disengaging the tab portion 312 from the projections 58 may include plastic and/or elastic deformation of one or both of the flange 320 and the corresponding projection 58. In some embodiments, the flange 320 may fracture and/or break away from the bracket module 244 when disengaging the carrier module 40 from the bracket module 244.

When the window balance assembly 220 is in the installed configuration, the bracket module 244 and the spring module 42 (and hence the curled portion 45 of the curl spring 43) may remain fixed relative to the window jamb 16, and the carrier module 40 (and hence the uncurled end 47 of the curl spring 43) may be movable relative to the window jamb 16 with the lower sash 14. Otherwise, operation of the window balance assembly 220 is generally similar to operation of the window balance assembly 20 in that the pivot bar 22 of the lower sash 14 may be inserted in to the cam 48 of the carrier module 40, as described above. Thereafter, the lower sash 14 may be rotated about the longitudinal axis of the pivot bar 22 to the upright position, which causes the cam 48 to rotate into the unlocked position, thereby allowing the carrier module 40 to move within the jamb channel 26. In the upright position, the lower sash 14 may be vertically movable with the carrier module 40 relative to the window jamb 16 and the spring and bracket modules 42, 244 between the open and closed positions. Therefore, the spring module 42 and carrier module 40 are vertically movable with the lower sash 14 relative to the window jamb 16.

It will be appreciate that the window balance assembly 220 can be installed through the cutout 21 in the window jamb 16, in a similar manner as described above with reference to the window balance assembly 20.

Referring now to FIGS. 9-11, yet another window balance assembly 420 is provided and may include a carrier module 440, the spring module 42 described above, and a bracket module 444. The spring module 42 may be disposed between the carrier module 440 and the bracket module 444. As will be subsequently described, the window balance assembly 420 is a fixed-coil window balance assembly, as the bracket module 444 and the spring module 42 (and hence the curled portion 45 of the curl spring 43) are fixed relative to the window jamb 16, while the carrier module 440 is movable with the lower sash 14 relative to the window jamb 16.

The carrier module 440 may be structurally and functionally similar to the carrier module 40 described above, apart from any exceptions noted below or shown in the figures. The carrier module 440 may include a carrier 446 and a cam 448. The cam 448 may be substantially similar or identical to the cam 48 described above, and therefore, will not be described again in detail. The carrier 446 may include a body 449, first guide surfaces 450, second guide surfaces 452, an attachment boss 454, an aperture 456 and projections 458. The first and second guide surfaces 450, 452 may be separated from each other by the aperture 456 and a generally V-shaped slot 462. Like the attachment boss 54 of the carrier module 40, the attachment boss 454 may include a profile that substantially matches that of the engagement aperture 66 of the uncurled end 47 of the curl spring 43. As in the window balance assembly 220, the uncurled end 47 may be fixed to the attachment boss 454 of the carrier module 440 by the screw 221.

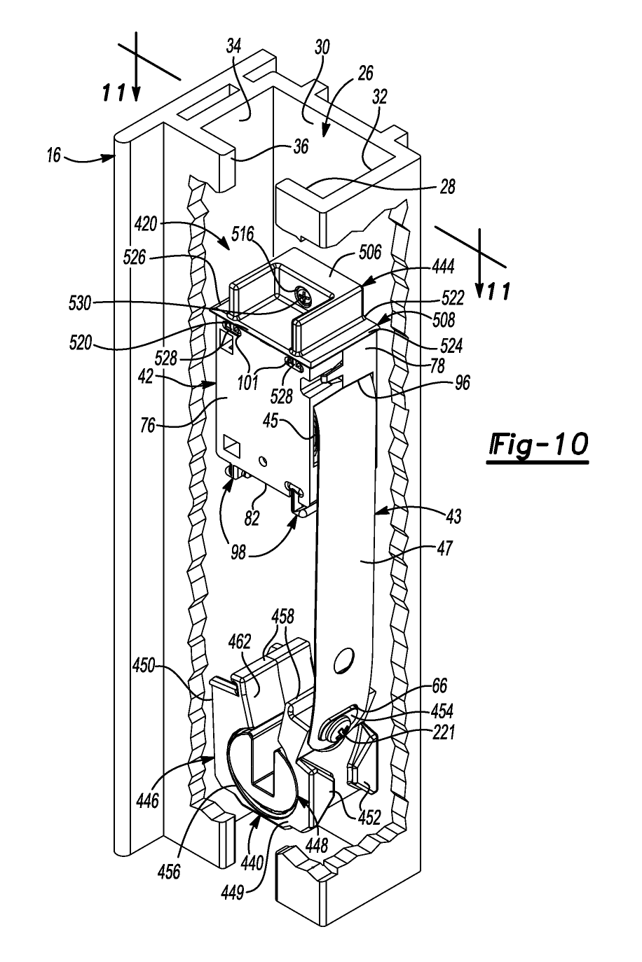

The cam 448 may be rotatably received in the aperture 456 and moveable between an unlocked position (FIG. 9) and a locked position (FIG. 10). In the locked position, the cam 448 may spread the body 449 to move the first and second guide surfaces 450, 452 further apart from each other. That is, in the locked position, the first guide surfaces 450 are forced against the fourth wall 34 of the jamb channel 26 and the second guide surfaces 452 are forced against the third wall 32 of the jamb channel 26. In the locked position, friction between the first and second guide surfaces 450, 452 and the fourth and third walls 34, 32, respectively, restricts or prevents the carrier module 440 (and hence the lower sash 14) from moving within the jamb channel 26.

When the window balance assembly 420 is in an uninstalled configuration (FIG. 9), the projections 98 of the spring module 42 may straddle the projections 458 such that the flanges 102 and bodies 103 of the projections 98 may releasably engage the projections 458 of the carrier module 440. In this manner, the carrier module 440 may be attached to the spring module 42 when the window balance assembly 420 is in the uninstalled configuration.

The bracket module 444 module may be molded and/or machined from a polymeric or metallic material, for example, and may include a body portion 506 and a flange portion 508. The body portion 506 may be generally U-shaped and may include a mounting aperture 516 extending therethrough.

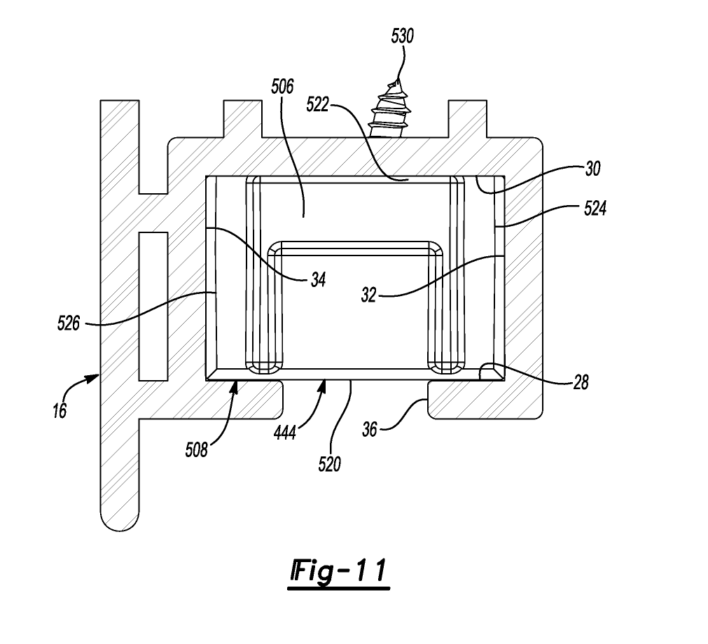

The flange portion 508 may include a generally rectangular shape to correspond to the rectangular shape of the jamb channel 26. The flange portion 508 may surround the body portion 506 and may extend generally outward from the body portion 506. In some embodiments, the flange portion 508 may be resiliently pliable or deflectable, while in other embodiments, the flange portion 508 may be relatively rigid. As shown in FIG. 11, first, second, third and fourth sides 520, 522, 524, 526 of the flange portion 508 may be in contact with the first, second, third and fourth walls 28, 30, 32, 34 of the jamb channel 26. In this manner, the flange portion 508 may act as a debris dam and prevent dust, dirt, and/or other contaminants or debris from accumulating in the jamb channel 26 and on the curl spring 43 and the carrier module 440, thereby preventing debris from increasing friction between moving parts of the window balance assembly 420. Generally T-shaped projections 528 may extend downward from the flange portion 508 and may engage the slots 101 of the spring module 42 via a press or interference fit, for example.

To install the window balance assembly 420 in the jamb channel 26, as shown in FIG. 10, an installer may drive a screw 530 through the mounting aperture 516 and into the second wall 30 of the jamb channel 26. Once the screw 530 is driven into the second wall 30, the carrier module 440 can be separated from the spring module 42 by pulling the carrier module 440 downward to disengage the projections 458 of the carrier module 440 from the projections 98 of the spring module 42. Disengaging the projections 458 from the projections 98 may include plastic and/or elastic deformation of one or more of the projections 458, 98. In some embodiments, one or more projections 458, 98 may fracture and/or break away from the carrier module 440 or spring module 42 when disengaging the carrier module 440 from the spring module 42. Otherwise, operation of the window balance assembly 420 may be generally similar to operation of the window balance assembly 220.

When the window balance assembly 420 is in the installed configuration, the bracket module 444 and the spring module 42 (and hence the curled portion 45 of the curl spring 43) may remain fixed relative to the window jamb 16, and the carrier module 440 (and hence the uncurled end 47 of the curl spring 43) may be movable relative to the window jamb 16 with the lower sash 14.

It will be appreciate that the window balance assembly 420 can be installed through the cutout 21 in the window jamb 16, in a similar manner as described above with reference to the window balance assembly 20.

It will be appreciated that in some embodiments, the spring module 42 could include a mounting aperture extending through the first and second housing portions 74, 76 that could receive the screw 530 or some other fastener so that the spring module 42 could be mounted to the window jamb 16 without the bracket module 444.

While the bracket modules 44, 244, 444 are described above as being secured to the window jamb 16 by a screw 118, 330, 530, it will be appreciated that the bracket modules 44, 244, 444 could be attached to the window jamb 16 in any other manner. For example, in some embodiments, the bracket modules 44, 244, 444 could include holes, slots, hooks, posts, tabs and/or other engagement features that are configured to engage holes, slots, hooks, posts, tabs and/or other engagement features formed on or in one or more of the walls 28, 30, 32, 34.

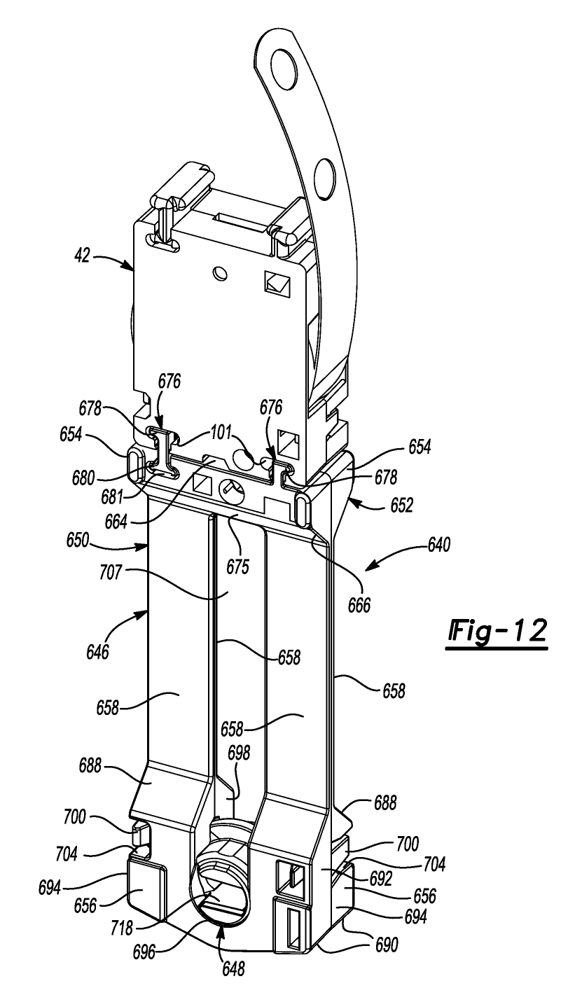

With reference to FIG. 12, another carrier module 640 is provided. The carrier module 640 can be incorporated into the window balance assemblies 20 in place of the carrier module 40.

The carrier module 640 may include a body 646 and a cam 648. The body 646 can be molded and/or machined from a polymeric or metallic material, for example, and may include first and second housing portions 650, 652. In some embodiments, the first and second housing portions 650, 652 may be similar or identical components that can engage each other and form a housing for the cam 648. Each of the first and second housing portions 650, 652 may include an upper body 654, a lower body 656 and a pair of legs 658 extending between the upper and lower bodies 654, 656. It will be appreciated that in some embodiments, the body 646 could be formed from a single piece or in any other suitable manner.

The upper body 654 may include a top end 664, a bottom end 666, a first side 668, and a second side 670. In some embodiments, the bottom end 666 may include an inclined surface 675 adjacent the legs 658. A projection 676 and a slot 681 may be disposed at the top end 664. The projection 676 may include a generally I-shaped cross-section having upper and lower flanges 678, 680. The slots 681 may be sized and shaped to enable the slots 681 of the first housing portion 650 and the second housing portion 652 to slidably engage the lower flanges 680 of the second housing portion 652 and the first housing portion 650, respectively. The lower flanges 680 may be securely received in the corresponding slots 678 by a snap fit, a press fit, a fastener and/or adhesive, for example, or any other suitable attachment means. The upper flanges 678 may engage slots 101 of the spring module 42 to attach the carrier module 640 to the spring module 42.

The lower body 656 may include a top end 688, a bottom end 690, a first side 692, and a second side 694. An aperture 696 may extend through the lower body 656 and may rotatably engage the cam 648. A first slot 698 in communication with the aperture 696 may extend through the lower body 656 and may extend vertically upward from the aperture 696 through the top end 688.

A first barbed protuberance 700 may be disposed at or proximate to the first side 692. A second slot 704 may be formed in the second side 694 generally opposite the first barbed protuberance 700. In this manner, when the first and second housing portions 650, 652 are assembled together, the first barbed protuberances 700 may engage the second slots 704. The engagement between the first barbed protuberances 700 and second slots 104 may be configured to allow the lower bodies 656 of the first and second housing portions 650, 652 to be movable relative to each other between a first position (corresponding to a tilted position of the lower sash 14) and a second position (corresponding to an upright position of the lower sash 14) without disengaging each other in a similar manner as described in Assignee's commonly owned U.S. patent application Ser. No. 13/390,680, the disclosure of which is incorporated by reference herein.

The legs 658 may interconnect the upper and lower bodies 654, 656 and may be integrally formed therewith. The legs 658 may be spaced apart from each other and may define a channel 707 therebetween. The channel 707 may be aligned with the first slot 698 and aperture 696 of the lower body 656.

The legs 658 may be resiliently flexible members having thicknesses that are relatively thin compared to the thicknesses of the upper and lower bodies 654, 656. This provides additional flexibility for the legs 658 to resiliently bend and flex about one or more horizontally extending axes. In some embodiments, the flexibility of the legs 658 may facilitate twisting of the carrier module 640 about a vertically extending axis. The flexibility of the legs 658 allows the window balance assembly 20 to be installed into the jamb channel 26 through a cutout 21 in the jamb channel 26 that is smaller than the window balance assembly 20. That is, the legs 658 allow the window balance assembly 20 to be resilient bent for insertion into the jamb channel 26 through the relatively small cutout 21. A method of inserting a window balance assembly into a cutout of a jamb channel is described in Assignee's commonly owned U.S. Provisional Application No. 61/759,007, the disclosure of which is incorporated by reference herein in its entirety.

The cam 648 may be generally similar to the cam 48 and may include a slot 718 that can receive a corresponding one of the pivot bars 22 extending from the lower sash 14. Like the cam 48 described above, the cam 648 may be rotatable within the aperture 696 between an unlocked position corresponding to an upright position of the lower sash 14 and a locked position corresponding to a tilted position of the lower sash 14. Rotation of the cam 648 may allow the lower sash 14 to pivot about a longitudinal axis of the pivot bar 22 between the upright position and the tilted position.

When the cam 648 is rotated into the locked position, the elliptical shape of the cam 648 causes the lower bodies 656 of the first and second housing portions 650, 652 of the carrier module 640 to move outward away from each other (but without disengaging each other). With the lower bodies 656 moved outward, the exterior faces of the lower bodies 656 may be forced against third and fourth walls 32, 34 of the jamb channel 26, thereby increasing the friction between the carrier module 640 and the jamb channel 26 to lock the carrier module 640 relative to the jamb channel 26. When the cam 648 is in the locked position, the slot 718 in the cam 648 may be substantially aligned with the channel 707 between the legs 658, the first slot 698 and the aperture 696 of the lower body 656. This alignment allows for “drop-in” installation of the pivot bar 22 into the cam 648 while the carrier module 640 is locked in place within the jamb channel 26.

When the cam 648 is in the unlocked position (i.e., oriented such that the slot 718 is horizontal), the interior faces of the lower bodies 656 may move toward each other (i.e., return to the unlocked or unrestricted position), such that the carrier module 640 may be generally unrestricted from moving upward and downward in the window jamb channel 26 as the lower sash 14 moves between the open and closed positions.

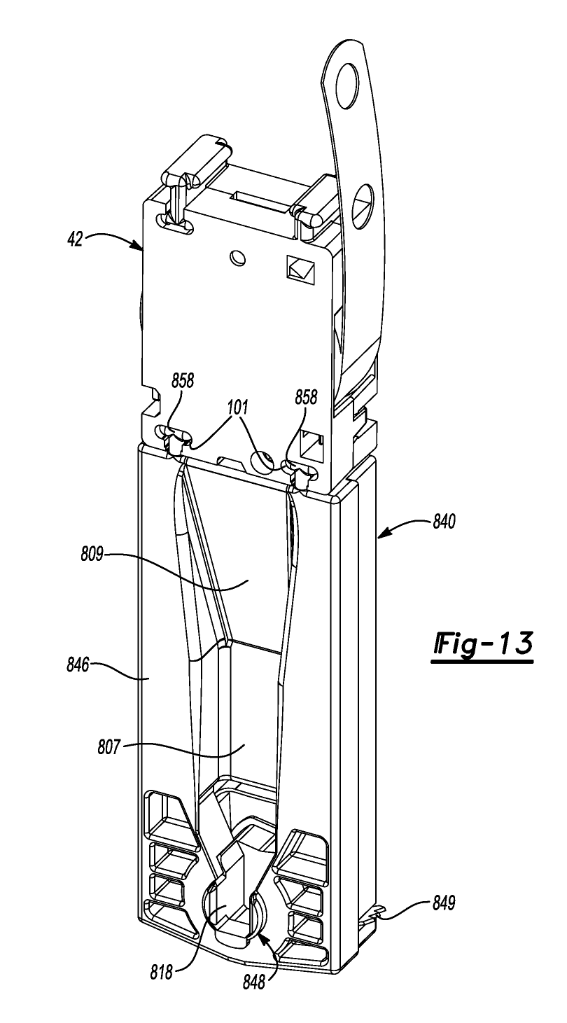

With reference to FIG. 13, another carrier module 840 is provided. The carrier module 840 can be incorporated into the window balance assemblies 20 in place of the carrier module 40. The carrier module 840 may include a body 846, a cam 848, and a deployable locking member 849. The cam 848 may be rotatably received in the body 846 between a locked position (shown in FIG. 13) and an unlocked position. In the locked position, the cam 848 may force the locking member 849 outward to engage one or more walls of the jamb channel 26 to fix the window balance assembly 20 relative to the jamb channel 26. In the unlocked position, the cam 848 may allow the locking member 849 to retract back into the body 846 to allow the window balance assembly 20 to move up and down within the jamb channel 26.

The body 846 may be formed as a single piece or the body 846 may include first and second housing portions similar to the body 646 described above. The body 846 may include generally T-shaped projections 858 that engage slots 101 of the spring module 42 to attach the carrier module 840 to the spring module 42. The body 846 may also include an elongated channel 807 that may be aligned with a slot 818 in the cam 848 when the cam 848 is in the locked position. As described above, this alignment allows for “drop-in” installation of the pivot bar 22 into the cam 848 while the carrier module 840 is locked in place within the jamb channel 26. In some embodiments, the channel 807 in the body 846 may include an inclined surface 809 adjacent an upper end of the body 846.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A set of components for assembling a window balance in one of at least two window balance assembly constructions, the set of components comprising:
a carrier module configured to receive a portion of a window sash and comprising a first engagement feature comprising a first projection disposed at a first end of the carrier module and a second engagement feature comprising a boss disposed on a first side of the carrier module;
a spring module comprising a curl spring and a housing, the curl spring having a curled portion and an uncurled end portion, and the housing containing the curled portion, the housing having a third engagement feature comprising a first slot disposed at a first end of the housing and a fourth engagement feature comprising a second projection disposed at a second end of the housing opposite the first end of the housing; and
a bracket module comprising a bracket selected from a first bracket and a second bracket, the first bracket comprising a first body portion comprising a fifth engagement feature comprising a latch, a first mounting aperture, and a sixth engagement feature comprising a first tab portion extending from the first body portion, and the second bracket comprising a second body portion comprising a second mounting aperture, a seventh engagement feature comprising a second slot disposed in the second body portion, and an eighth engagement feature comprising a second tab portion extending from the second body portion;
wherein in a first window balance assembly construction the first bracket is selected and the first engagement feature directly engages the third engagement feature, the fourth engagement feature directly engages the sixth engagement feature, and the fifth engagement feature directly engages the uncurled end portion of the curl spring; and
wherein in a second window balance assembly construction the second bracket is selected and the first engagement feature directly engages the eighth engagement feature, the fourth engagement feature directly engages seventh engagement feature, and the second engagement feature directly engages the uncurled end portion of the curl spring.

2. The set of components of claim 1, wherein in the first window balance assembly construction the fourth engagement feature releasably engages the sixth engagement feature; and
wherein the first window balance assembly construction comprises a moving-coil window balance assembly.

3. The set of components of claim 1, wherein in the second window balance assembly construction the first engagement feature releasably engages the eighth engagement feature; and
wherein the second window balance assembly construction comprises a fixed-coil window balance assembly.

4. The set of components of claim 1, wherein the portion of the window sash comprises a pivot bar; and
wherein the carrier module comprises a rotatable cam configured to engage the pivot bar.

5. The set of components of claim 4, wherein the carrier module comprises an aperture in which the cam is rotatable and an elongated slot aligned with the aperture.

6. The set of components of claim 1, wherein the uncurled end portion of the curl spring comprises an engagement aperture; and
wherein the second engagement feature comprises an attachment boss shaped to accommodate a shape of the engagement aperture.

7. A set of components for assembling a window balance in one of at least two window balance assembly constructions, the set of components comprising:
a carrier module configured to receive a portion of a window sash and comprising a first engagement feature disposed at a first end of the carrier module and a second engagement feature disposed on a first side of the carrier module;
a spring module comprising a curl spring and a housing, the curl spring comprising a curled portion and an uncurled end portion, and the housing containing the curled portion, the housing having a third engagement feature disposed at a first end of the housing and a fourth engagement feature disposed at a second end of the housing opposite the first end of the housing; and
a mounting bracket comprising one of a first bracket and a second bracket, the first bracket comprising a fifth engagement feature and a sixth engagement feature, and the second bracket comprising a seventh engagement feature and an eighth engagement feature;
wherein in a first window balance assembly construction the first engagement feature directly engages the third engagement feature, the fourth engagement feature releasably engages the sixth engagement feature, and the fifth engagement feature directly engages the uncurled end portion of the curl spring; and
wherein in a second window balance assembly construction the first engagement feature releasably engages the eighth engagement feature, the fourth engagement feature directly engages seventh engagement feature, and the second engagement feature directly engages the uncurled end portion of the curl spring.

8. The set of components of claim 7, wherein the first engagement feature comprises a first projection disposed at a first end of the carrier module;
wherein the third engagement feature comprises a first slot disposed at a first end of the housing;
wherein the fourth engagement feature comprises a second projection disposed at a second end of the housing opposite the first end of the housing;
wherein the fifth engagement feature comprises a latch extending outward from the first bracket; and
wherein the sixth engagement feature comprises a tab portion extending from the first bracket.

9. The set of components of claim 7, wherein the first engagement feature comprises a first projection disposed at a first end of the carrier module;
wherein the second engagement feature comprises a boss disposed on a first side of the carrier module;
wherein the fourth engagement feature comprises a second projection disposed at a second end of the housing opposite the first end of the housing;
wherein the seventh engagement feature comprises a slot disposed in the second bracket; and
wherein the eighth engagement feature comprises a tab portion extending from a body of the second bracket.

10. The set of components of claim 9, wherein the uncurled end portion of the curl spring comprises an engagement aperture; and
wherein the second engagement feature comprises an attachment boss shaped to accommodate a shape of the engagement aperture.

11. The set of components of claim 7, wherein the portion of the window sash comprises a pivot bar; and
wherein the carrier module further comprises a rotatable cam configured to engage the pivot bar.

12. The set of components of claim 11, wherein the carrier module further comprises an aperture in which the cam is rotatable and an elongated slot aligned with the aperture.

13. The set of components of claim 11, wherein the carrier module further comprises an upper body, a central portion, and a lower body; and
wherein the central portion is disposed between the upper body and the lower body and comprises a pair of resiliently flexible legs extending between the upper body and the lower body.

14. The set of components of claim 11, wherein the carrier module further comprises a body comprising an elongated channel aligned with the slot in the cam when the cam is in a first position and an inclined surface adjacent an upper end of the body.

15. A method of assembling a set of components into one of at least two window balance assembly constructions, the method comprising:
providing a carrier module configured to receive a portion of a window sash and comprising a first engagement feature disposed at a first end of the carrier module and a second engagement feature disposed on a first side of the carrier module;
providing a spring module comprising a curl spring and a housing, the curl spring comprising a curled portion and an uncurled end portion, and the housing containing the curled portion, the housing having a third engagement feature disposed at a first end of the housing and a fourth engagement feature disposed at a second end of the housing opposite the first end of the housing; and
providing a first bracket comprising a fifth engagement feature and a sixth engagement feature;
providing a second bracket comprising a seventh engagement feature and an eighth engagement feature;
connecting the first engagement feature to one of the third engagement feature and the eighth engagement feature; and
wherein if the first engagement feature is connected to the third engagement feature, then connecting the fourth engagement feature to the sixth engagement feature and connecting the uncurled end portion of the curl spring to the fifth engagement feature; and
wherein if the first engagement feature is connected to the eighth engagement feature, then connecting the fourth engagement feature to the seventh engagement feature, and connecting the uncurled end portion of the curl spring to the second engagement feature.

16. A method according to claim 15, wherein connecting the fourth engagement feature to the sixth engagement feature comprises releasably connecting the fourth engagement feature to the sixth engagement feature.

17. A method according to claim 15, wherein connecting the first engagement feature to the eighth engagement feature comprises releasably connecting the first engagement feature to the eighth engagement.

18. A method according to claim 15 wherein providing a carrier module further comprises providing a carrier module comprising an upper body, a central portion, and a lower body, wherein the central portion is disposed between the upper body and the lower body and comprises a pair of resiliently flexible legs extending between the upper body and the lower body.

19. A method according to claim 15 wherein providing a carrier module further comprises providing a carrier module comprising a cam, an aperture in which the cam is rotatable, and a body comprising an elongated channel aligned with the slot in the cam when the cam is in a first position and an inclined surface adjacent an upper end of the body.
